(19) United States
(12) Patent Application Publication
(10) Pub. No.: US 2014/0013032 A1
(43) Pub. Date: Jan. 9, 2014

(54) METHOD AND APPARATUS FOR CONTROLLING WRITING DATA IN STORAGE UNIT BASED ON NAND FLASH MEMORY

(71) Applicants: Research & Business Foundation SUNGKYUNKWAN UNIVERSITY, (US); SAMSUNG ELECTRONICS CO., LTD., Gyeonggi-do (KR)

(72) Inventors: Changwoo MIN, Seoul (KR); Hyunjin CHO, Seoul (KR); Kangnyeon KIM, Gyeonggi-do (KR); Young IK EOM, Seoul (KR); Sang Won LEE, Gyeonggi-do (KR)

(73) Assignees: Research & Business Foundation SUNGKYUNKWAN UNIVERSITY, Gyeonggi-do (KR); Samsung Electronics co., Ltd., Gyeonggi-do (KR)

(21) Appl. No.: 13/753,118

(22) Filed: Jan. 29, 2013

(30) Foreign Application Priority Data
Jul. 3, 2012 (KR) 10-2012-0072083

(51) Int. Cl. G06F 12/02

(52) U.S. Cl. CPC G06F 12/0246
USPC 711/103

(57) ABSTRACT

A method and apparatus for controlling writing of data in a storage unit based on a NAND flash memory are provided. The method includes determining reference values for classifying dirty pages to be written in the storage unit into a plurality of groups; calculating, with respect to each of the dirty pages, a hotness indicating a possibility of a change of data; classifying the dirty pages into the groups corresponding to reference values most similar to the calculated hotness; determining whether sizes of the groups are greater than a size of a segment, where the segment is a unit for performing a write request in the storage unit; and requesting a write operation for each segment with respect to groups having a size at least equal to the size of the segment to the storage unit.

### PRIORITY

This application claims priority under 35 U.S.C. §119(a) to a Korean patent application filed on Jul. 3, 2012 in the Korean Intellectual Property Office and assigned Serial No. 10-2012-0072083, the entire content of which is incorporated herein by reference.

### BACKGROUND OF THE INVENTION

1. Field of the Invention

The present invention relates to a method and apparatus for controlling writing data, and more particularly, to a method for controlling writing of data in a storage unit based on a NAND flash memory, and an apparatus thereof.

2. Description of the Related Art

Flash-based Solid State Drive (SSDs), which are used as secondary memory units, have been under continuous development and improvement over the last decade, and have excellent performance and power consumption as compared to Hard Disk Drives (HDDs). In general, HDDs operate by mechanically writing and reading data into and from a circular plate shaped disc. However, since SSDs write and read data using chemical and electrical reactions of a semiconductor chip, SSDs are robust against external shock and do not generate excessive heat. Accordingly, storage units based on NAND flash memory tend to be applied to storage units of portable terminals, such as notebook computers, tablet Personal Computers (PCs), and smart phones.

However, in SSDs based on NAND flash memory, the performance of random write operations is not ideal. The bandwidth for a random write operation is more than ten times that required for a sequential write operation, even in current SSDs. Accordingly, a throughput of a random write operation is significantly less than a throughput of the sequential write operation. Erase operations with respect to a block from a random write operation may occur more frequently as compared with erase operations with respect to sequential write operations. Accordingly, the random write operation shortens NAND flash memory's lifespan. In NAND flash memory, in order to overwrite a page, an entire block including the page must be erased before the page is overwritten. A block of a NAND flash memory includes a plurality of pages (e.g., 128 pages). In particular, in NAND flash memory, write operations may be performed with respect to individual pages (e.g., 2 KB or 4 KB), while an erase operation is performed with respect to entire blocks (e.g., 64 or 128 pages). Accordingly, a block erase requires more time than a page write. The number of times a block can be erased is limited in the NAND flash memory. For example, the block erase number of a Single-Level Cell (SLC) is less than or equal to 100,000, the block erase number of a Multi-level Cell (MLC) is less than or equal to 10,000, and the block erase number of a Triple Level Cell (TLC) is less than or equal to 1,000. If a block is erased more times than the corresponding number, reliability of data stored in the block cannot be guaranteed. Particularly, as capacities of SSDs increase due to improvements of integration of the NAND flash memory, the number of erase operations that can be performed rapidly decreases.

A storage unit based on NAND flash memory has a firmware called Flash Translation Layer (FTL) in consideration of a unique characteristic of the NAND flash memory. The FTL converts a Logical Block Address (LBA) requested from a file system (an element of OS) that is an upper layer of the FTL into a Physical Page Address (PPA) and performs computations such as read and write operations. Further, FTL stores and manages a conversion table for converting a logic block address and a physical page address. The FTL also controls allocation with respect to the physical page address to increase duration of the storage unit, by ensuring that specific cells of the NAND flash memory are not rapidly eroded, but that entire cells are uniformly eroded instead. Such a function is referred to as wear-leveling. Random write operations generate internal fragmentation between logic blocks addresses and physical page addresses. That is, when the random write operations are generated, a physical page may be invalidated, and garbage collection for recycling invalidated physical pages may rapidly increase. Accordingly, each time a random write operation is requested (e.g., an application program requests an Operating System (OS) to perform a write operation), the number of block erase operations with respect to the NAND flash memory increases, which reduces a performance and a duration of the NAND flash memory.

Several methods for addressing performance and duration reduction occurring due to random writes in a storage unit based on the NAND flash memory are described as follows.

One such method extends an over-provisioning space in the NAND flash memory. An idle memory space that a user cannot use in a NAND flash memory is referred to as an over-provisioned space. If the over-provisioning space is large, even when a random write is generated, the chance of internal fragmentation may be reduced to improve the performance and the duration. In general, 5-25% of memory capacity is used as an idle memory space. However, this method increases hardware costs.

Another method minutely maps addresses. In this method, mapping between the logic block address and the physical page address is minutely performed. Through this method, the internal fragmentation may be reduced and the performance and duration reduction according to the random write operation may be reduced. Hybrid mapping of mapping a data block for each block and a log block for each page is more efficient than performing block unit mapping for each block. Meanwhile, page mapping the data block and the log block are more efficient. However, as the mapping units decrease in size, a capacity of a memory (e.g., Static RAM (SRAM)) in a storage unit for storing a mapping table must be increased, which disadvantageously increases hardware costs.

Another optimization method uses a logic block address. The FTL provides various methods for optimizing using a logic block address requested from a file system. For example, an optimizing method is used to optimize an update frequency according to logic address blocks. Although the current optimization method is efficient when requesting an update in the same logic block address while updating a file block, the same method inefficient when allocating another logic block address while updating a file block.

### SUMMARY OF THE INVENTION

The present invention has been made to address the above-described problems and provide at least the advantages described below. An aspect of the present invention provides a method of controlling writing for improving a performance of a slow random write and a duration thereof which is an important problem of a storage unit based on a NAND flash memory, and an apparatus thereof.

In accordance with an aspect of the present invention, a method of controlling writing data in a storage unit based on a NAND flash memory, is provided. The method includes determining reference values for classifying dirty pages to be written in the storage unit into a plurality of groups; calculating, with respect to each of the dirty pages, a hotness indicating a possibility of a change of data; classifying the dirty pages into the groups corresponding to reference values most similar to the calculated hotness; determining whether sizes of the groups are greater than a size of a segment, where the segment is a unit for performing a write request in the storage unit; and requesting a write operation for each segment with respect to groups having a size at least equal to the size of the segment to the storage unit.

In accordance with another aspect of the present invention, an apparatus of controlling writing data is provided. The apparatus includes a storage unit including a NAND flash memory; and a controller for controlling writing of the data in the storage unit, the controller for determining reference values for classifying dirty pages to be written in the storage unit into a plurality of groups, calculating, with respect to each of the dirty pages, a hotness indicating a possibility of a change of data, classifying the dirty pages into the groups corresponding to reference values most similar to the calculated hotness, determining whether sizes of the groups are greater than a size of a segment, where the segment is a unit for performing a write request in the storage unit, and requesting a write operation for each segment with respect to groups having a size at least equal to the size of the segment to the storage unit.

### BRIEF DESCRIPTION OF THE DRAWINGS

The objects, features and advantages of the present invention will be more apparent from the following detailed description in conjunction with the accompanying drawings, in which:

FIG. 1 is a histogram illustrating throughput of a random write operation according to a requested size according to an embodiment of the present invention;

FIG. 2 is a block diagram illustrating a configuration of an apparatus according to an embodiment of the present invention;

FIG. 3 is a flowchart illustrating a write operation in an apparatus including a storage unit based a NAND flash memory according to an embodiment of the present invention;

FIG. 4 is a flowchart illustrating an iterative segment quantization method according to an embodiment of the present invention;

FIG. 5 is a histogram illustrating an example of segment quantization according to an embodiment of the present invention;

FIG. 6 is a flowchart illustrating segment cleaning according to an embodiment of the present invention; and

FIGS. 7 and 8 are diagrams illustrating experimental results of a file system and another file system according to an embodiment of the present invention.

### DETAILED DESCRIPTION OF EMBODIMENTS OF THE PRESENT INVENTION

Embodiments of the present invention are described as follows with reference to the accompanying drawings. Throughout the drawings, the same or similar reference numbers may be used to refer to the same or similar parts. Detailed descriptions of well-known functions and structures incorporated herein may be omitted to avoid obscuring the subject matter of the present invention.

Methods and apparatuses for controlling writing data in a storage unit based on a NAND flash memory according to embodiments of the present invention are applicable to multi-media devices such as smart phones, tablet PCs, notebook PCs, desktop PCs, TVs, navigation devices, and video phones. Such multi-media devices may also be convergence devices (e.g., a refrigerator having a communication function and a touch screen).

In order to address problems occurring due to a random write operation in a storage unit based on a NAND flash memory, embodiments of the present invention suggest a log-Structured File System (SFS), which is a new file system. The related art concentrates improvement in a performance of a random write operation in an FTL. Meanwhile, embodiments of the present invention provide a method and an apparatus for controlling writing of data having the same level as a file system of an upper layer, in contrast to the FTL level of conventional schemes.

The SFS according to embodiments of the present invention is a file system designed so that a random write operation is requested for each block, in order to minimize the number of block erases. For example, a storage unit based a NAND flash memory, (e.g., an SSD) is a unit of a clustered page and performs read and write operations. The clustered page is configured by a plurality of physical pages. When the size of a request is not a multiple of a size of the clustered page, the read or write operation is additionally performed. For example, when the request size and a size of the clustered page are 64K, the operation is performed only once. However, when the size of the clustered page is 16 k, which is less than the clustered page size of 64K, an additional operation is performed. The additional operation deteriorates the performance of the SSD. When the number of additional operations increases, garbage collection also increases. Accordingly, the number of block erases with the NAND flash memory for each request of the random write operation is increased to reduce the performance and the duration. When the request size is a multiple of the size of the clustered block, the number of block erases may be minimized. That is, when the request size is the same as the block size, the performance of the random write operation converges to the performance of a sequential write operation.

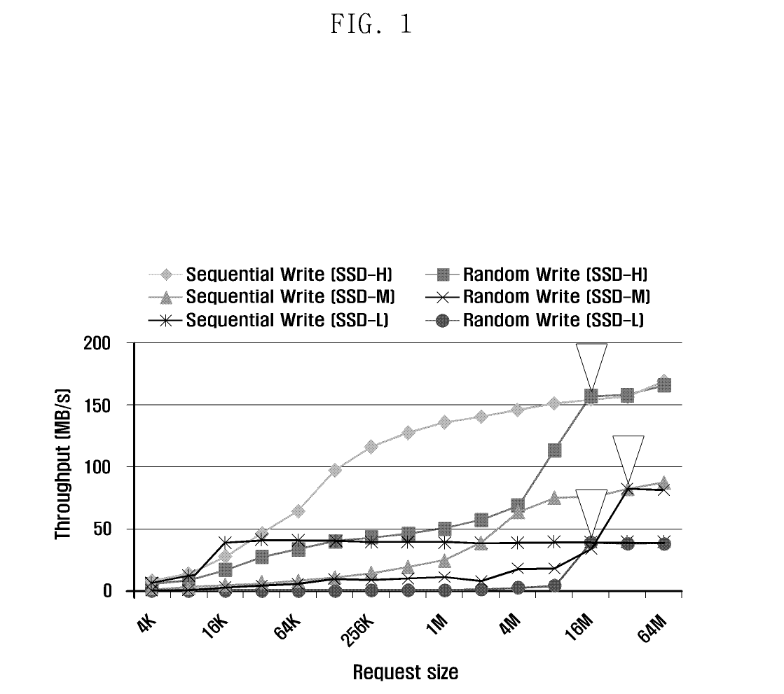

FIG. 1 is a histogram illustrating throughput of a random write operation according to a requested size according to an embodiment of the present invention.

Referring to FIG. 1, throughput of the random write operation and throughput of the sequential write operation in an SSD of three types is measured. A specification of an SSD used in the measurement is shown in Table 1 below. As illustrated in FIG. 1, when the request size is the same as the block size, the performance of the random write operation converges to the performance of the sequential write.

TABLE 1

| | SSD-H | SSD-M | SSD-L |
|---|---|---|---|
| Manufacturer | Intel | Samsung | Transcend |
| Model | X25-E | S470 | JetFlash 700 |
| Capacity | 32 GB | 64 GB | 32 GB |
| Interface | SATA | SATA | USB 3.0 |
| flash memory | SLC | MLC | MLC |
| Max Sequential Reads (MB/s) | 216.9 | 212.6 | 69.1 |
| Random 4 KB reads (MB/s) | 13.8 | 10.6 | 5.3 |
| Max Sequential Writes (MB/s) | 170 | 87 | 38 |
| Random 4 KB Writes (MB/s) | 5.3 | 0.6 | 0.002 |
| Price($/GB) | 14 | 2.3 | 1.4 |

The SFS transforms all random write operations of a file system level into a sequential write operation of a storage device (e.g., an SSD) level, and requests the storage device to perform the sequential write operation. In particular, a case of updating an existing file block, the SFS invalidates the existing block, and allocates a new logic block address and transforms the random write operation into the sequential write operation. Since the sequentially transformed write operation does not cause internal fragmentation, the performance reduction and the duration reduction due to the random write operation may be prevented. In order to continuously request a sequential write operation of a predetermined size to the storage device, existing invalidated blocks are recycled and a live or valid block mixed between invalidated blocks is delivered for recycling. Embodiments of the present invention include (a) a scheme of classifying data block before the write operation and (b) a scheme of selecting a segment to be recycled, namely, a victim by cost-hotness to minimize a segment cleaning delivering the valid block. The schemes are described in detail below.

In following description according to embodiments of the present invention, a segment is a unit that an SFS requests to be written to the storage device. The SFS sets the size of the segment and requests writing to the storage device for each set segment. One segment may include a live or valid block having valid data (i.e., the newest data), and a dead or invalid block having invalid data (i.e., namely, previous data). When initially performing writing of each segment, all blocks of the segment may be valid blocks. When the block is updated, the updated blocks are delivered to a new segment, and existing blocks are transformed into invalid blocks.

To continue the write operation for each segment, an invalid block must be recycled. To recycle an invalid block, a first procedure for selecting the segment and a second procedure for delivering only valid blocks to another segment are required. After all valid blocks of a selected segment are delivered, a corresponding segment may be recycled for a write operation. This series of procedures is referred to as a segment cleaning in accordance with embodiments of the present invention. The segment selected by the first procedure is referred to as a victim, and a segment to be recycled (namely, a segment for a write operation) by the second procedure is referred to as a free segment. A reference for selecting the segment is referred to as a policy. Herein, the term “hotness”, in accordance with embodiments of the present invention, indicates a possibility of changing some data. When the hotness is great, the change possible is high, and hen the hotness is small, the change possible is low. For example, the change possibility may be classified into hot, warm, and cold which are three stages. “Hot” is the highest change possibility, “warm” indicates an intermediate change possibility, and “cold” indicates the lowest change possibility.

Herein, a dirty page according to embodiments of the present invention is a page that exists in an upper layer (e.g., a cache memory) of a storage device, and refers to a page that is changed, but is not written, in the storage device.

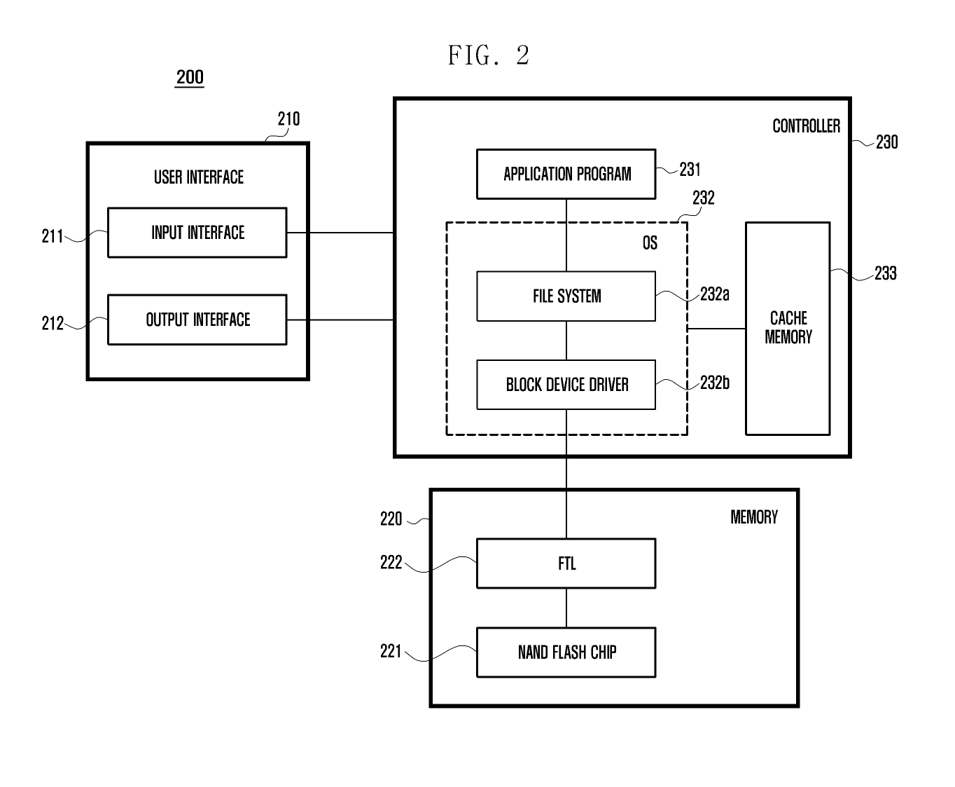

FIG. 2 is a block diagram illustrating a configuration of an apparatus according to an embodiment of the present invention.

Referring to FIG. 2, the apparatus 200 includes a user interface 210, a memory 220, and a controller 230.

The user interface 210 interacts with a user, and includes an input interface 211 and an output interface for visually, audibly, and/or touchably providing feedback to the user, in response to input information that the input interface 211 receives. For example, the input interface 211 may include a touch panel, a microphone, a sensor, a camera, and a Global Positioning System (GPS) receiver. The output interface 222 may include, for example, a display unit, a speaker, and a vibration motor.

The touch panel, which may be placed on the display unit, generates and transfers touch data to the controller 230 in response to a touch gesture of the user. The touch panel may be implemented by as add-on type panel located on the display unit, an on-cell type inserted in the display unit, or an in-cell type panel. The touch panel and the display unit are used together to provide a touch screen. The controller 230 detects touch data and controls the apparatus 200 in response to the touch data. The microphone receives a voice such as a voice of the user, converts the received voice into an electric signal (Analog to Digital (AD)), converts the electric signal into audio data, and outputs the digital audio data to the controller 230. The controller 230 detects voice data from the received audio data, and controls the apparatus 200 in response to voice data.

The sensor detects a state change of the apparatus 200, and generates and outputs detection data associated with the detected state change to the controller 230. For instance, the sensor may include at least one of various sensors such as an acceleration sensor, a gyro sensor), a luminance sensor, a proximity sensor, and a pressure sensor.

The controller 230 detects detection data and controls the apparatus 200 in response to the detection data. A camera photographs a subject and outputs an image of the subject to the controller 230. The camera may include a lens for collecting light, an image sensor for converting the collected light into an electric signal, and an Image Signal Processor (ISP) for converting the electric signal from the image sensor into image data and outputting the image data to the controller 230. The ISP processes (e.g., compresses) the image data and outputs the image data to the controller 230. The controller 230 detects image data and controls the apparatus 200 in response to the detection data. A GPS receiver receives a GPS signal from a GPS satellite, calculates a location of the apparatus 200 using the received GPS signal, and outputs the calculated location information to the controller 230. The controller 230 detects location information, and controls the apparatus 200 in response to the location information.

The display unit converts image data from the controller 230 into an analog signal, and displays the analog signal. The display unit includes a display panel such as a Liquid Crystal Display (LCD), an Organic Light Emitting Diode (OLED) or an Active Matrix Organic Light Emitting Diode (AMOLED). A speaker converts audio data from the controller 230 into a voice and outputs the voice. A vibration mode provides haptic feedback. For example, when the touch data are detected, the controller 230 controls vibrations of the vibration motor.

The memory 220 is a secondary memory unit of the apparatus 200, and stores data (e.g., character messages, photographed images) generated from the apparatus 200, or data received from outside of the apparatus 200. The memory 220 stores various setting values (e.g., screen brightness, presence of vibrations during generation of a touch, presence of automatic rotation of a screen) for operating the apparatus 200. The memory 220 stores a booting program and an operating system and various application programs for operating the apparatus 200. Herein, the application program may include embedded applications as well as third party applications. The booting program is loaded in a main storage device (e.g., Random Access Memory (RAM)) of the controller 230. The booting program loads an OS in the main storage device so that the apparatus 200 may operate. The OS loads the application program in the main storage device to be executed.

The memory 220 includes a NAND flash chip 221 and a Flash Translation Layer (FTL) 222. The NAND flash chip 221 includes a host interface logic, an array, and a controller of NAND flash memories. The FTL 222 is run by the controller, and exposes a linear array of a logic block address to a host (i.e., controller 230) to emulate an HDD. In order to reduce the number of erase operations, the FTL 222 performs functions including: (1) a function of managing a mapping table for mapping a logic block address to a physical page address, (2) a garbage collection for recycling invalidated physical pages, and (3) wear-leveling so that all cells are uniformly eroded.

The controller 230 controls overall operations of the apparatus 200, signal flow between internal constituent elements of the apparatus 200, and processes data. The controller 230 includes a main storage device having an application program 231 and an OS 232, a cache memory 233 for temporarily storing data to be written in the memory 220 and data read from the memory 220, a Central Processing Unit (CPU), and a Graphic Processing Unit (GPU).

The OS 232 manages computer resources, such as a CPU, a GPU, a main storage device, and a secondary storage device, while managing an interface between hardware and an application program. The OS 232 operates the apparatus 200, determines an order of tasks, and controls computations of a CPU and a GPU. The OS 232 controls execution of application programs and manages storage of data and files. The OS 232 includes an SFS 232a and a block device driver 232b. When the application program 231 requests a write operation, the OS 232 processes a write request. The SFS 232a in the OS 232 transforms a request for a file of the application program 231 into a request for a logic block address and transfers the request for a logic block address to the block device driver 232b. The block device driver 232b converts a request received from a file system 232a into a command suited to the memory 220 and transfers the command to an FTL 222 of the memory 220. The FTL 222 receives the logic block address and a command (i.e., a write request) from the block device driver 232b, converts the received logic block address into a physical page address, and transfers the physical page address to the NAN flash chip 221. The NAND flash chip 221 receives the physical page address and the command, and performs writing in the received physical page address according to the command (i.e., the write request).

A CPU is a main control unit of a computer system performing computation and comparison of data, interpretation and execution of commands. The GPU is a graphic control unit performing computation and comparison of data associated with graphics and interpretation and execution of a command instead of the CPU. The CPU and the GPU may be integrated into a single package in which at least two independent cores (e.g., four cores in a quad-core configuration) are achieved by a single integrated circuit. The CPU and the GPU may be included in a System on Chip (SoC) configuration integrated on one chip. The CPU and the GPU may be packaged in a multi-layer configuration. A configuration including the CPU and the GPU may also be referred to as an Application Processor (AP) herein.

Since the structural elements of the apparatus 200 according to embodiments of the present invention can be changed in various ways according to the convergence trend of digital devices, the apparatus 200 may further include other elements that are not mentioned, including, but not limited to, a wired communication unit for connecting to an external device (e.g., PC) in a wired scheme, a Radio Frequency (RF) communication unit (e.g., mobile communication module (e.g., 3rd-Generation mobile communication module, 3.5-Generation mobile communication module, 4th-Generation mobile communication module), a Digital Broadcasting Module (e.g., Digital Multimedia Broadcasting (DMB) module) and a near field communication (NFC) module (e.g., a Wi-Fi module, a Bluetooth module, etc.)).

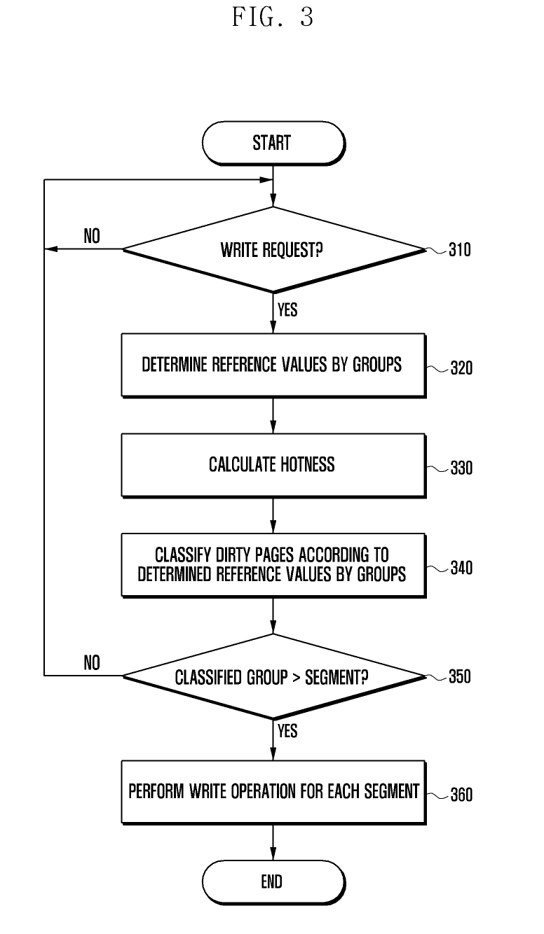

FIG. 3 is a flowchart illustrating a write operation in an apparatus including a storage unit based a NAND flash memory according to an embodiment of the present invention.

Referring to FIG. 3, when a write request occurs in an application program 231 at step 310, a controller 230 determines reference values of groups for classifying dirty pages in a cache memory 233 into a plurality of groups, in step 320. According to an embodiment of the present invention, an iterative segment quantization method may be used to determine the reference values.

The controller 230 calculates hotness with respect to dirty pages existing in the cache memory 233, in step 330. According to an embodiment of the present invention, file block hotness, file hotness, and segment hotness, for example, may be calculated.

The controller 230 classifies the dirty pages into groups according to the determined reference values, in step 340. For example, the dirty pages may be classified into a hot group, a warm group, or a cool group.

The controller 230 determines whether the size of the classified group is greater than that of a segment, in step 350. The size of the segment may be set as a multiple of the size of a block (e.g., the same as the size of the block) in order to converge a performance of a random write operation to a performance of a sequential write operation as described above. The block is an erase unit in the NAND flash memory. The memory 220 performs an erase operation for each block under control of the controller 230. One block includes a plurality of pages (e.g., 128 pages).

When the size of the group is at least equal to the size of the segment, the controller 230 transmits a message requesting a write operation for each segment to the memory 220, in step 360. The message includes a logic block address and data of a segment unit (i.e., dirty pages). The memory 220 performs a write operation for each segment (i.e., for each block) in response to the request message. In this case, after the write operation is performed for each segment, the write operation may be performed with respect to remaining dirty pages.

When the size of the group is less than the size of the segment, the controller 230 does not transmit a write request message to the memory 220 and returns to step 310. Only when the size of the group is greater than the size of the segment, the controller 230 may control execution of the write operation.

The method of controlling a write operation according to an embodiment of the present invention described above classifies blocks having similar hotness and one segment is configured only according to blocks having the same hotness. Accordingly, because all blocks included in one segment have a similar hotness level, there is a high possibility that one configured segment includes mostly valid blocks or mostly invalid blocks. When a segment having many invalid blocks (i.e., a segment having few valid blocks) is selected as victim during segment cleaning, since the number of valid blocks to be delivered becomes too few, an additional overhead required in the segment cleaning may be reduced. Because a ratio of valid/invalid blocks, which a file system 232 for a write request of an application program 231 requests a write operation to the memory 220, is reduced, a duration of the NAND flash memory may be extended.

A method of calculating hotness according to an embodiment of the present invention is described as follows. As described above, hotness is an indicator indicating a possibility of a change of data. A higher level of hotness refers to a higher change possibility. According to embodiments of the present invention, when the number of updates of data is high and the newest data is updated, the controller 230 determines that the corresponding hotness is high. According to embodiments of the present invention, the hotness may be fined by

$$“ \frac{w rite count}{age} ” .$$

Accordingly, the hotness may be proportional to the write count but inversely proportional to an age. Herein, “age” refers to a time elapsed after corresponding data is updated. The controller 230 according to embodiments of the present invention calculates a hotness H_{b} indicating a change possibility of a file block, a file hotness H_{f} indicating a change possibility of a file, and a segment hotness Hₛ indicating a change possibility of a segment using following Equations (1) to (3).

$${H}_{b} = \{ \begin{matrix}\frac{{W}_{b}}{T - {T}_{b}^{m}} & if {W}_{b} > 0 , \\ {H}_{f} & otherwise .\end{matrix} \qquad ( 1 )$$

In the Equations, W_{b} is a total number of write operations in a corresponding block, T is a current time, and T^{m}_{b} is a last modified time of a corresponding block. As described above, an erase operation is performed for each block. According to embodiments of the present invention, a write operation is performed for each block. When the corresponding block is newly generated (W_{b}=0), W_{b} is defined as a hotness H_{f} of a file belonging to the corresponding block.

$${H}_{f} = \frac{{W}_{f}}{T - {T}_{f}^{m}} \qquad ( 2 )$$

In Equation (2), W_{f} is a total number of write operations in a corresponding file (e.g., a file generated by an application program such as text file or image file), T is a current time, and T^{m}_{f} is a last modified time of a corresponding file. The file includes a plurality of blocks. When one of the blocks is updated, W_{f} may be counted.

$$\begin{matrix}{H}_{s} = \frac{1}{N} {\sum }_{i} {H}_{bi} \approx \frac{mean of write count of live blocks}{mean of age of live blocks} \\ = \frac{{\sum }_{i} {W}_{bi}}{N \cdot T - {\sum }_{i} {T}_{bi}^{m}}\end{matrix} \qquad ( 3 )$$

A valid block and an invalid block may both exist in one segment. The change possibility is determined by the valid block. Accordingly, the segment hotness Hₛ may be defined by an average of respect hotnesses of valid blocks in a corresponding segment. Since validity of all blocks in the segment should be tested, a significant amount of calculation is required in order to calculate the average

$$\frac{1}{N} {\sum }_{i} {H}_{bi} .$$

Accordingly, the controller 230 may calculate the segment hotness Hₛ by dividing a mean write count of live blocks in valid blocks by a mean of age of live blocks in the valid blocks as an approximate value with respect to an average. More specifically, the controller 230 stores a first sum ΣᵢT_{bi}^{m} of ages and a second sum ΣᵢW_{bi} of write count of valid blocks by segments. Each time the valid block is converted into an invalid block, the controller 230 may subtract an age and write count of an invalid block from the first and second sums to efficiently calculate hotnesses by segments. In Equation (3), H_{bi}, T_{bi}^{m}, and W_{bi} refer to a hotness, the last modified time, and the write count, respectively.

As a method of determining a hotness reference value for classifying dirty pages into groups, an iterative segment quantization method is used in accordance with embodiments of the present invention. Respective dirty pages are classified into a group having the most similar reference value to corresponding hotness. The hotness reference values of each group may be determined by according to a hotness distribution of entire blocks. However, an overhead for performing such a calculation is very significant. Accordingly, according to embodiments of the present invention, the hotness reference value may be determined by using a distribution of the segment hotness. An iterative segment quantization method according to the present invention is described as follows.

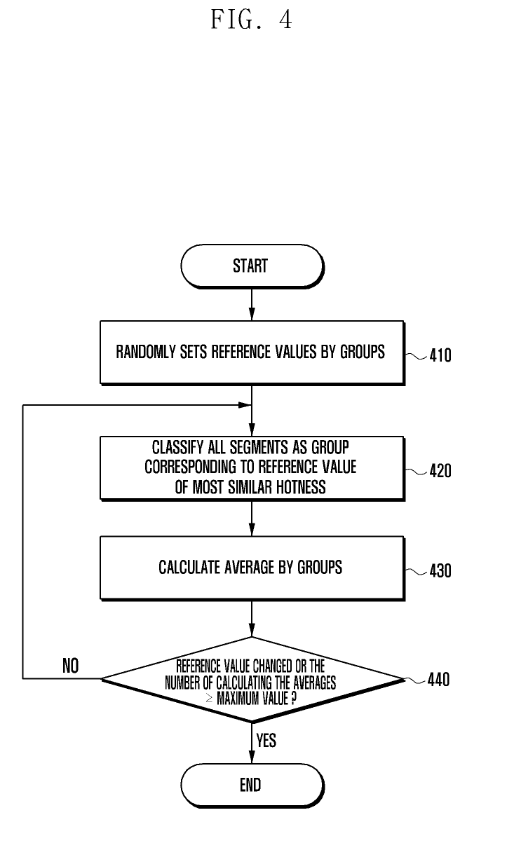

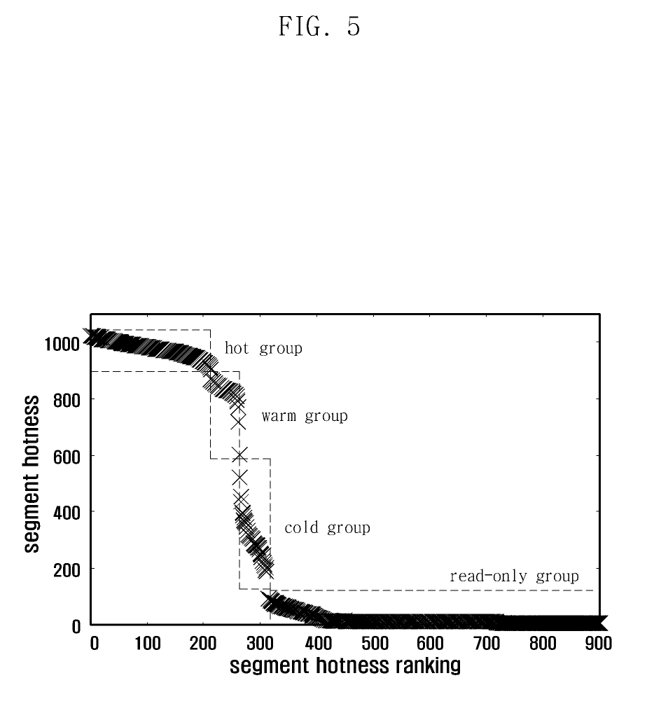

FIG. 4 is a flowchart illustrating an iterative segment quantization method according to an embodiment of the present invention, and FIG. 5 is a histogram illustrating an example of segment quantization according to an embodiment of the present invention.

Referring to FIG. 4, a controller 230 randomly sets reference values by groups, in step 410. For example, referring to FIG. 5, when the segment hotness has a range of 0-1000, a reference value of a hot group may be set to 900, a reference value of a warm group may be set to 700, an a reference value of a cold group may be set to 300, and a reference value of a read-only group may be set to 50.

The controller 130 classifies all segments into a group having the similar reference value to corresponding hotness, in step 420. For instance, when the segment hotness is 850, a corresponding segment is classified into a hot group. When the segment hotness is 600, the corresponding segment is classified into a warm group. When the segment hotness is 400, the corresponding segment is classified into a cold group. When the segment hotness is 100, the corresponding segment is classified into a read-only group.

The controller 230 calculates averages of segment hotnesses according to groups, and updates the respective averages as a reference value of a corresponding group. in step 430.

The controller 230 determines whether the reference value is changed or whether the number of calculating the average value (namely, the number of executions of step 430) is at least equal to a preset maximum value (e.g., 3), in step 440.

When the reference value is changed (i.e., when the current reference value differs from a previous reference value) or when the number of calculated average value is less than the preset maximum value, the process returns steps 420 and 430. When the number of calculated reference values is less than a preset maximum value (e.g., 3), the controller 230 repeats steps 420 and 430. Accordingly, the controller 230 reclassifies all segments by groups using updated reference values of groups, and again calculates an average of reclassified segment hotness by groups, and subsequently performs step 440.

Segment cleaning is a necessary operation in order that a file system 232 continuously performs a sequential write operation for the segment size. FIG. 4 illustrates an entire procedure corresponding to the segment cleaning. The segment cleaning may start when a ratio of free segments is less than or equal to a threshold value, when a check-point may be generated by a sync operation, or when there is an idle time.

The SFS transforms all random write operations of a file system level to a sequential write operation of a storage device (e.g., an SSD) level. The segment cleaning may be performed periodically (e.g., every 30 seconds). The segment cleaning may also be performed when all data of a main storage device (e.g., RAM) in which an OS 232 is managed by a sync operation are written in a secondary storage device, namely, a memory 220. The segment cleaning may also be performed when a space of a main memory is insufficient, contents of a main memory are stored in the memory 220 and a corresponding main memory is used as another application.

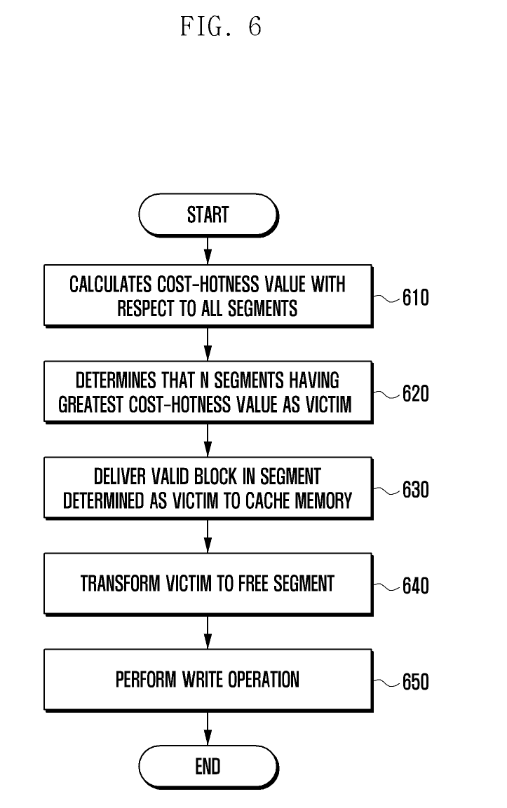

FIG. 6 is a flowchart illustrating segment cleaning according to an embodiment of the present invention.

Referring to FIG. 6, a controller 230 initially calculates a cost-hotness value with respect to all segments stored in a disc, namely, a memory 220, in step 610. According to embodiments of the present invention, the cost-hotness value indicates a suitable degree for which a corresponding segment is selected as a victim. A higher cost-hotness value corresponds to a higher fitness of a victim. The controller 230 determines that n segments having the greatest cost-hotness value as victims, in step 620. The controller 230 delivers a valid block in a segment determined as a victim to a cache memory 233, in step 630. In other words, the controller 230 reads the valid block from the victim and writes the read valid block to the cache memory 233 as a dirty page. The controller 230 transforms the victim to a free segment, in step 640, and performs a write operation of FIG. 3 with respect to the dirty page (read valid block), in step 650.

When the corresponding segment is determined as the victim in step 620, the value of the cost-hotness, which is determined according to Equation (4) below, increases along with an increase in an amount of recycle free blocks (i.e. “free space generated” in Equation (4)), and decreases along with an increase in a change possibility Hₛ of a corresponding segment. Many valid blocks in a segment should be delivered. When a cost is high, the cost-hotness has a low value, as shown in Equation (4), as follows:

$$\begin{matrix}Cost \text{-} hotness = \frac{free spaced generated}{cost \times segment hotness} \\ = \frac{( 1 - {U}_{s} )}{2 {U}_{s} {H}_{s}}\end{matrix} \qquad ( 4 )$$

Herein, Uₛ is a ratio of valid blocks in a corresponding segment.

A method of preventing data loss of a block during segment cleaning is described as follows. A valid block in a segment determined as victim in FIG. 6 is grouped according to the method described with reference to FIG. 3 and written in the memory 220. When the size of the group to which a valid block belongs is less than the size of the segment, the valid block is stored in the cache memory 233 as a dirty page, and a write operation of the valid block may be delayed. When a victim having on-disk copy of the write-delayed valid block is overwritten as new data in a state that a write operation of the valid block is delayed, the on-disk copy is not stored in a disk (i.e., the memory 220). When there is no on-disk copy, a system crash of the apparatus 200 occurs, or the apparatus 200 suddenly powers-off, a valid block having that does not have a corresponding dirty page in the cache memory 233 (i.e., on-disk copy) may be lost.

Two examples of methods for preventing loss of the valid block according to embodiments of the present invention are described as follows.

When the controller 230 sends a request for a write operation to the memory 220, the controller 230 performs the request such that the oldest free segment freed in the free segment list is allocated as a segment for a first write operation. Accordingly, since the latest freed segment is allocated as the last write segment, a possibility of disappearance of an on-disk copy of a valid block during segment cleaning may be reduced. Secondly, when the segment is allocated in the foregoing method, an allocation order of the segment is fixed. It is assumed that a free segment allocated as current write operation is Sₜ and a free segment to be allocated by a next segment allocation request is Sₜ₊₁. First, the controller 230 determines whether an on-disk copy of each page with respect to dirty pages during the segment cleaning belongs to Sₜ₊₁. If there is a dirty page, the controller 230 performs a write operation regardless of grouping (step 340 of FIG. 3), and subsequently performs a write operation by grouping.

As described above, embodiments of the present invention provide an SFS for converting a request for a random write operation into a request for a sequential write operation that does not cause internal fragmentation of a storage unit. Embodiments of the present invention provide a method of classifying blocks by groups before performing a write operation to minimize a segment cleaning overhead having the SFS and a method for determining a victim among segments using a cost-hotness scheme. Such methods according to embodiments of the present invention can improve a write performance of a file system regardless of a write pattern. Since an internal fragmentation of a storage unit does not occur, a minimum block erase may occur to improve a duration of a storage unit based on a NAND flash memory.

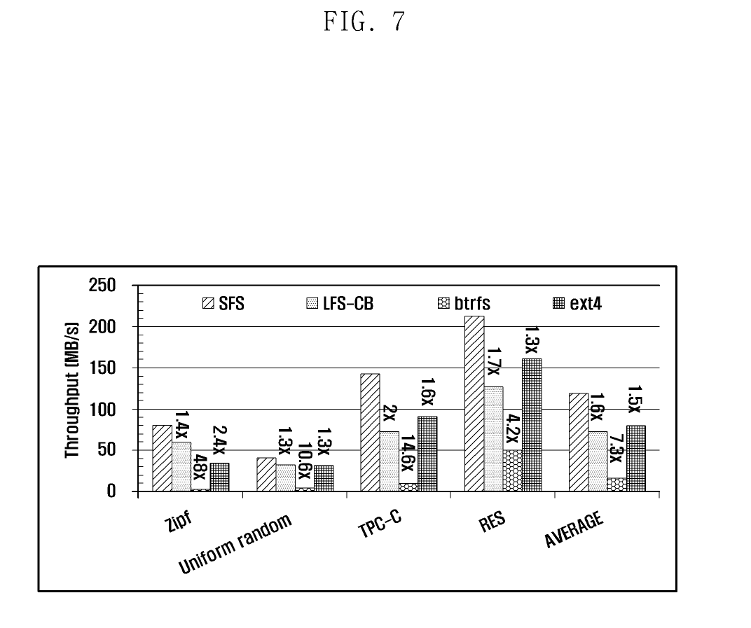

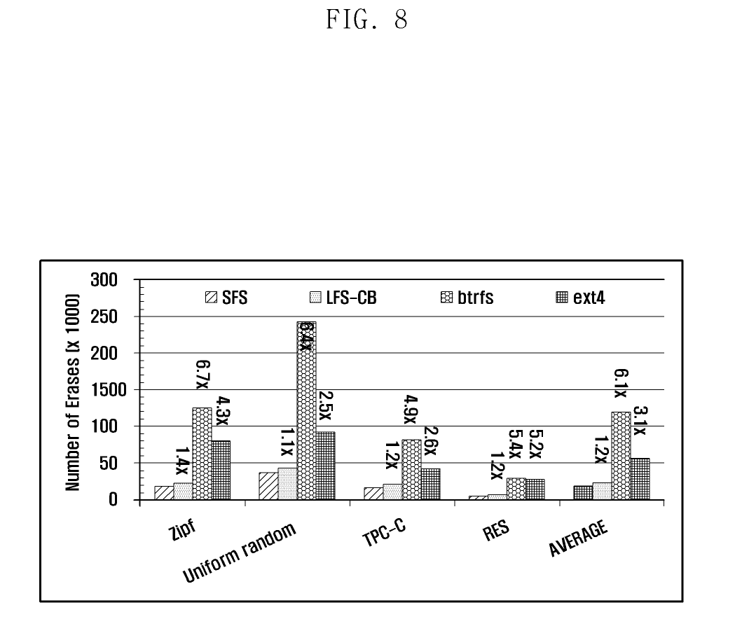

A file system according to embodiments of the present invention may be compared with other file systems to survey such effects. Results of such a comparison are illustrated in FIGS. 7 and 8. However, embodiments of the present invention are not limited to the experimental environments used in the following examples.

Experimental Workload
Zipf: random write workload (Zipf) having Zipf(refer to “http://wikipedia.org/wiki/Zipf %27s_law”) distribution
Uniform random: random write workload having uniform distribution
TPC-C: TPC-C benchmark (refer to “http://www.tpc.org/tpcc/spec/tpcc_current.pdf.”)
RES: Research result of laboratory in University of California (refer to “D. Roselli, J. R. Lorch, and T. E. Anderson. A comparison of file system workloads. In Proceedings of USENIX Annual Technical Conference, ATEC '00, pages 4.4, Berkeley, Calif., USA, 2000. USENIX Association.”)

Comparison Target File System
Method (SFS) of the present invention
SFS using no scheme of the present invention (refer to LFS-CB; “M. Rosenblum and J. K. Ousterhout. The design and implementation of a log-structured file system. ACM Trans. Comput. Syst., 10:26.52, February 1992.”)
ext4 file system (refer to “A. Mathur, M. Cao, S. Bhattacharya, A. Dilger, A. Tomas, and L. Vivier. The new ext4 filesystem: current status and future plans. In Proceedings of the Linux Symposium, June 2007.”)
btrfs file system (refer to “http://btrfs.wiki.kernel.org.”)

Referring to FIG. 7, throughput of file systems by workloads is described according to an example where disk utilization is 85%. As shown by this example, performance of a file system according to embodiments of the present invention is greater than that of other file systems. Referring to FIG. 8, the number of erases causing file systems by workloads is also described according to an example where disk utilization is 85%. As shown by this example, the number of erases of a file system according to embodiments of the present invention is significantly less than that of other file systems.

The foregoing methods for controlling writing data in a storage unit based on a NAND flash memory of according to embodiments of the present invention may be implemented as executable programs used by various computer means and may be recorded in a computer readable recording medium. In this case, the computer readable recording medium may include a program command, a data file, and a data structure individually or a combination thereof. Meanwhile, the program command recorded in a recording medium may be specially designed or configured for embodiments of the present invention.

The computer readable recording medium may include Magnetic Media such as hard disks, floppy disks, or magnetic tapes, Optical Media such as Compact Disc Read Only Memory (CD-ROM) or Digital Versatile Discs (DVDs), Magneto-Optical Media such as floptical disks, and a hardware devices such as Read-Only Memory (ROM), Random Access Memory (RAM), and flash memory for storing and executing program commands. Further, a program command according to embodiments of the present invention may include a machine language code created by a complier and a high-level language code executable by a computer using an interpreter. The foregoing hardware device may be configured to be operated as at least one software module to perform an operation of the present invention.

According to the methods and apparatuses of embodiments of the present invention, performance of a random write operation of an apparatus having a NAND flash memory, and the duration of the apparatus are improved.

Although methods and apparatuses for controlling a random write operation in an apparatus having a storage unit based on a NAND flash memory are described according to embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of controlling writing of data in a storage unit based on a NAND flash memory, the method comprising:
determining reference values for classifying dirty pages to be written in the storage unit into a plurality of groups;
calculating, with respect to each of the dirty pages, a hotness indicating a possibility of a change of data;
classifying the dirty pages into the groups corresponding to reference values most similar to the calculated hotness;
determining whether sizes of the groups are greater than a size of a segment, where the segment is a unit for performing a write request in the storage unit; and
requesting a write operation for each segment with respect to groups having a size at least equal to the size of the segment to the storage unit.

2. The method of claim 1, wherein the size of the segment is a multiple of the size of a block, where the block is an erase unit of the NAND flash memory.

3. The method of claim 1, wherein the hotness is proportional to a write count of corresponding data, and is inversely proportional to an age indicating an elapsed time after the corresponding data is updated.

4. The method of claim 3, wherein calculating the hotness comprises calculating at least one of a segment hotness indicating a change possibility of the segment, a file block hotness indicating a change possibility of a block that is an erase unit of the NAND flash memory, and a file hotness indicating a change possibility of a file configured by a plurality of blocks.

5. The method of claim 4, wherein calculating the hotness further comprises:
storing a first sum of ages and a second sum of write counts of valid blocks in the segment; and
calculating a segment hotness by subtracting an age and a write count of an invalid block from the first and second sums,
wherein the valid block is a block having newest valid data, and the invalid block is a block having previous invalid data.

6. The method of claim 1, wherein determining the reference values comprises:
randomly setting the reference values; and
classifying all segments into the groups corresponding to the reference values most similar to the calculated hotness; and
calculating averages of the hotness of each group and updating the reference values of each group according to the calculated averages,
repeatedly performing the classification of the dirty pages and the updating of the reference values until the reference values are changed as a result of the update or until the number of the calculations of averages reaches a preset maximum value.

7. The method of claim 1, further comprising performing a segment cleaning before determining the reference values and calculating the hotness with respect to each of the dirty pages,
wherein performing the segment cleaning comprises:
calculating a cost-hotness value with respect to all segments, the cost-hotness value is a value for determining whether a corresponding segment is suitable to be selected as a victim, where the victim is a selected segment for which the write operation is allowed;
selecting segments having a greatest cost-hotness value as victims; and
delivering a valid block in a segment selected as a victim to a cache memory as a dirty page, and converting the delivered block as a writable free segment.

8. The method of claim 7, wherein the cost-hotness value increases as an amount of recyclable free blocks increases and a change possibility of a corresponding segment decreases.

9. The method of claim 7, wherein requesting the write operation for each segment comprises requesting such that the oldest free segment freed in the free segment list is allocated as a segment for a first write operation.

10. The method of claim 7, further comprising requesting a write operation regardless of the classifying the group with respect to the dirty page belonging to a next segment allocation request Sₜ₊₁ following a free segment allocated as current write Sₜ when there is a dirty page belong to the Sₜ₊₁.

11. An apparatus of controlling writing of data, the apparatus comprising:
a storage unit including a NAND flash memory; and
a controller for controlling writing of the data in the storage unit,
the controller for determining reference values for classifying dirty pages to be written in the storage unit into a plurality of groups, calculating, with respect to each of the dirty pages, a hotness indicating a possibility of a change of data, classifying the dirty pages into the groups corresponding to reference values most similar to the calculated hotness, determining whether sizes of the groups are greater than a size of a segment, where the segment is a unit for performing a write request in the storage unit, and requesting a write operation for each segment with respect to groups having a size at least equal to the size of the segment to the storage unit.

12. The apparatus of claim 11, wherein the controller set the size of the segment as a multiple of the size of a block, where the block is an erase unit of the NAND flash memory.

13. The apparatus of claim 11, wherein the controller calculates the hotness, which is proportional to write count of corresponding data, and is inversely proportional to an age indicating an elapsed time after the corresponding data is updated.

14. The apparatus of claim 11, wherein the controller randomly sets the reference values, classifies all segments into the groups corresponding to the reference values most similar to the calculated hotness, and calculates averages of the hotness of each group and updates the reference values of each group according to the calculated averages, and
repeatedly performs the classification of the dirty pages and the updating of the reference values until the reference values are changed as a result of the update or until the number of the calculations of averages reaches a preset maximum value.

15. The apparatus of claim 11, wherein the controller performs a segment cleaning before determining the reference values and calculating the hotness with respect to each of the dirty pages,
wherein, in performing the segment cleaning, the controller
calculates a cost-hotness value with respect to all segments, the cost-hotness value is a value for determining whether a corresponding segment is suitable to be selected as a victim that is a selected segment for which the write operation is allowed,
selects segments having a greatest cost-hotness value as victims, and
delivering a valid block in a segment selected as a victim to a cache memory as a dirty page, and converting the delivered block as a writable free segment.

16. A recording medium implemented in an apparatus of controlling writing of data in a storage unit based on a NAND flash memory, the recording medium comprising:
determining reference values for classifying dirty pages to be written in the storage unit into a plurality of groups;
calculating, with respect to each of the dirty pages, a hotness indicating a possibility of a change of data;
classifying the dirty pages into the groups corresponding to reference values most similar to the calculated hotness;
determining whether sizes of the groups are greater than a size of a segment, where the segment is a unit for performing a write request in the storage unit; and
requesting a write operation for each segment with respect to groups having a size at least equal to the size of the segment to the storage unit.
